(19) United States
(12) Patent Application Publication
(10) Pub. No.: US 2002/0184961 A1
(43) Pub. Date: Dec. 12, 2002

(54) Handi-driver

(76) Inventor: Keith Alan Roberts, Melbourne, FL (US)

Correspondence Address: Keith A. Roberts, 118 Dale Ave., Melbourne, FL, 32935, US

(21) Appl. No.: 09/876,873

(22) Filed: Jun. 8, 2001

(51) Int. Cl. G05G 11/00; G05G 13/00

(52) U.S. Cl. 74/481; 74/484 R

(57) ABSTRACT

The “Handi-Driver” provides at least three functions at the steering column, this allows a disabled person, to operate and drive an automobile with an automatic transmission, by using one hand controll. An automobile with a standard transmission can be operated and driven, by using two hand controlls.

A business such as a restaurant that offers food to patrons, parking, access, restrooms and ramps are nessasary for handicapped patrons to participate.

A business that offers other activites for patrons, such as a Family Fun Center with concession go-karting, does not have go-karts availible for handicapped patrons, by modifing a concession go-kart with the“Handi-Driver”, a disabled person can operate and drive a go-kart by hand.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF THE INVENTION

Automobile steering column and steering wheels activate one function, steering only. The “Handi-Driver” steering lever and steering column, activates at least three functions by the use of one hand. A motorized vehicle with an automatic transmission, can be driven using one “Handi-Driver”, steering, throttle and brakes. A motorized vehicle with a standard transmission, can be driven by using two “Handi-Driver” hand controlls.

Concession go-karting is an industry that provides go-karting to the general public. The “Handi-Driver” allows a disabled patron to safely controll and drive a concession go-kart by hand. Without this invention the “Handi-Driver” no go-karts are on the market for disabled patrons. A concession go-kart park could decline service to a disabled patron, without fear of discrimination. With the “Handi-Driver” all concession go-kart parks can offer handicap accessible go-karts.

### BRIEF SUMMARY OF THE INVENTION

When this device the “Handi-Driver” is applied to a motorized vehicle, a disabled person, someone with leg paralysis or leg amputee, can safely controll, and drive a motorized vehicle with an automatic or standard transmission, by the use of one or two “Handi-Driver” hand controlls.

### BRIEF DESCRIPTION OF THE DRAWING VIEWS

FIG. 1 EXPLODED VIEW, FIG. 1 illistrates the “Handi-Driver”, and all of the mechanical elements.

FIG. 2 ALTERNATE POSITION, side view. FIG. 2 is the BRAKING. Pushing the brake lever, pulls the brake cable.

FIG. 3 ALTERNATE POSITION, side view. FIG. 3 is the STEERING. Moving steering lever left to right, rotates the steering columns

FIG. 4 ALTERNATE POSITION, side view. FIG. 4 is the THROTTLE. Twisting the hand throttle, moves the throttle cable.

FIG. 5 ALTERNATE POSITION, side view. FIG. 5 is a “Handi-Driver” in its position, on a motorized vehicle.

FIG. 6 ALTERNATE POSITION, side view. FIG. 6 is the CLUTCH lever, pushing the clutch lever, moves the clutch cable.

FIG. 7 ALTERNATE POSITION, top view. FIG. 7 illistrates the CLUTCH lever motion, disengaged, engaged, engaged and locked, Gear shifter lever, gear shifter positions.

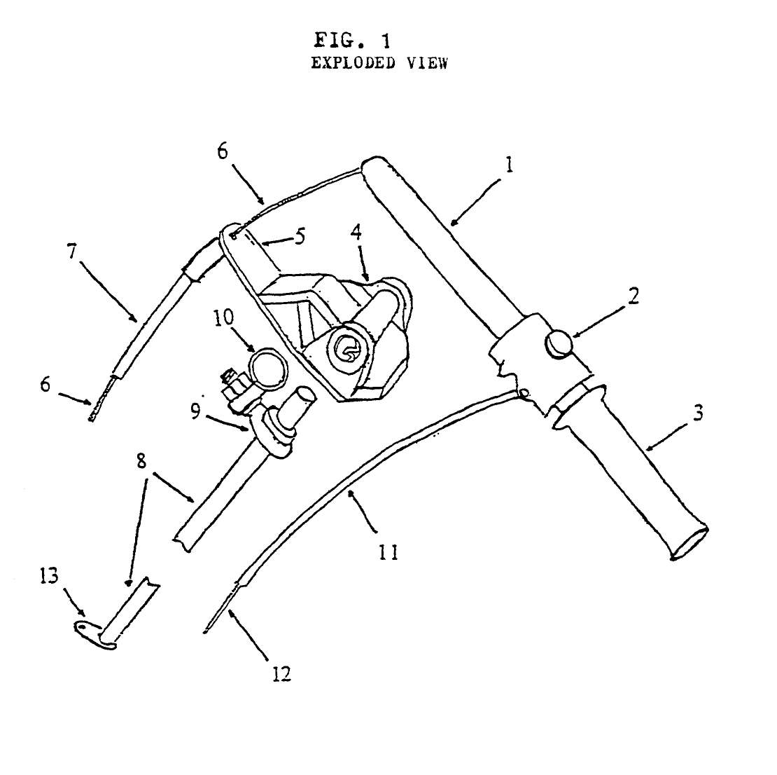

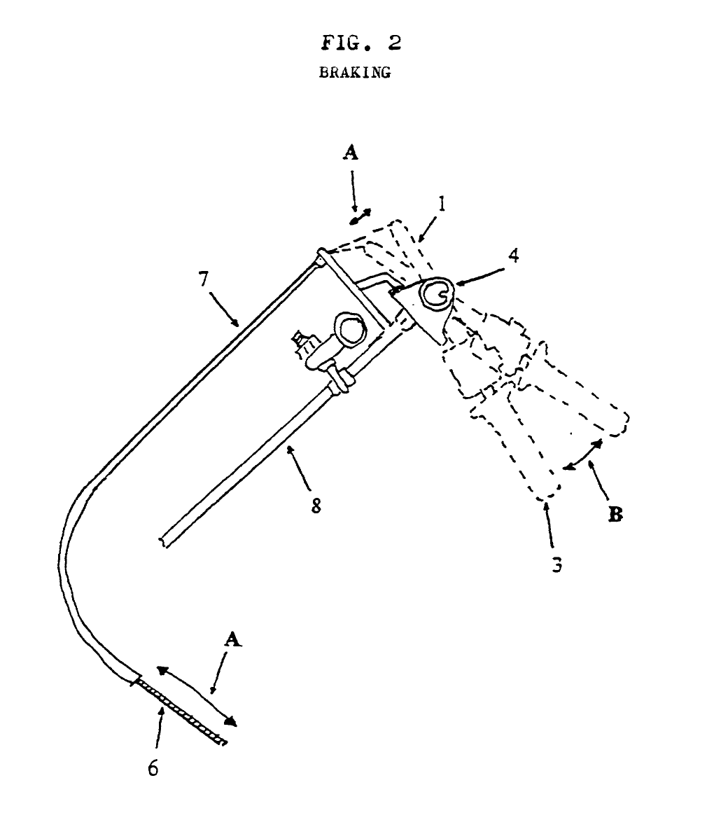

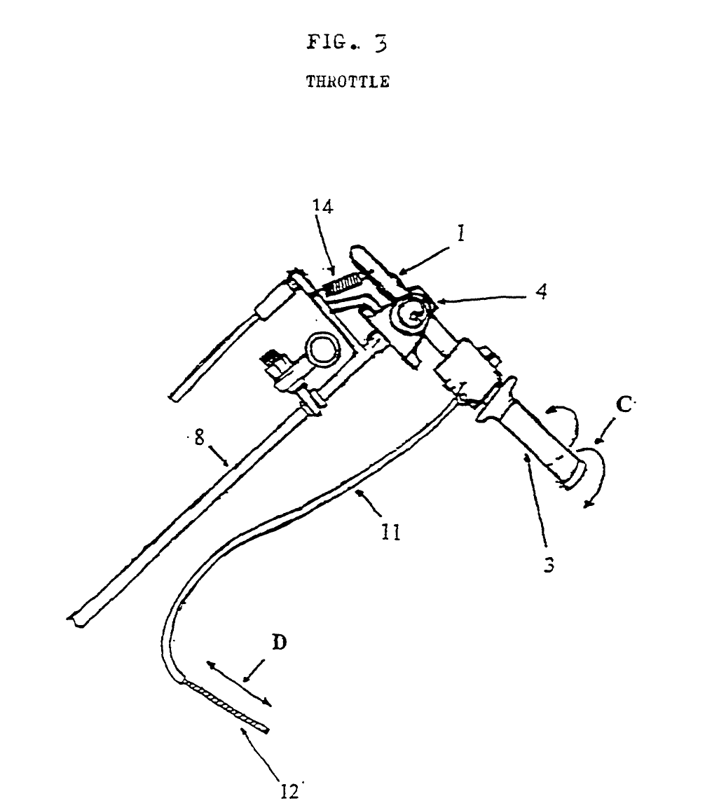

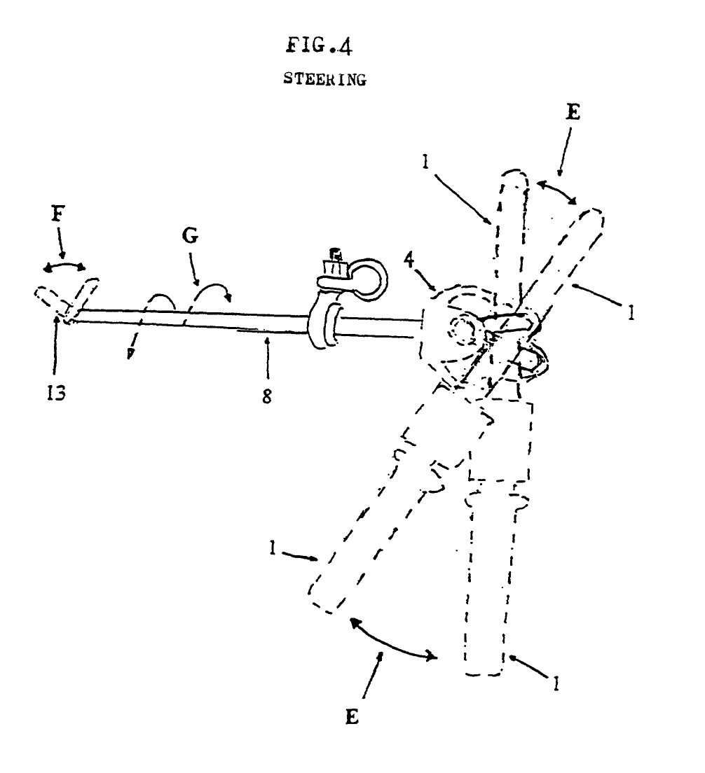

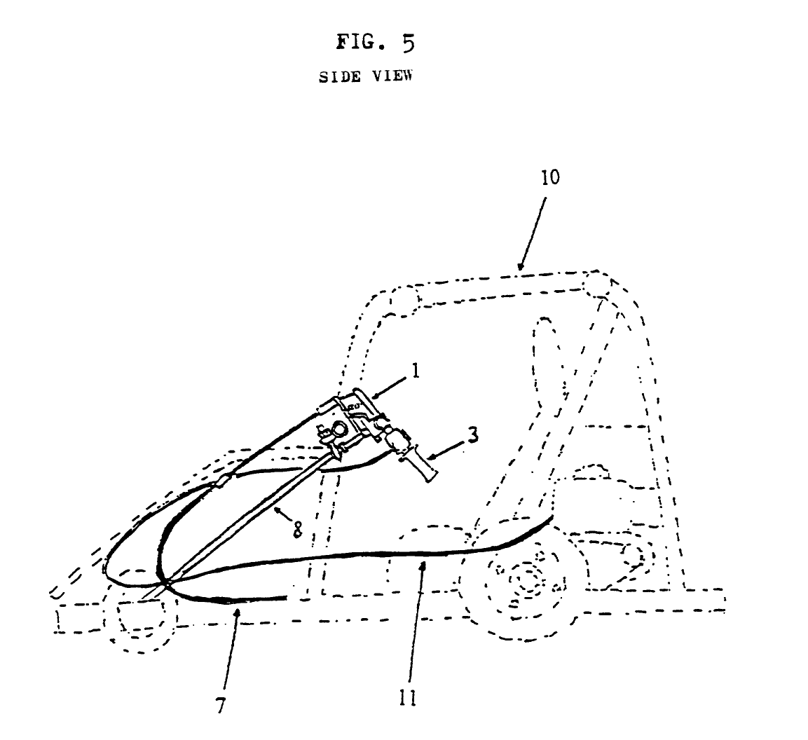

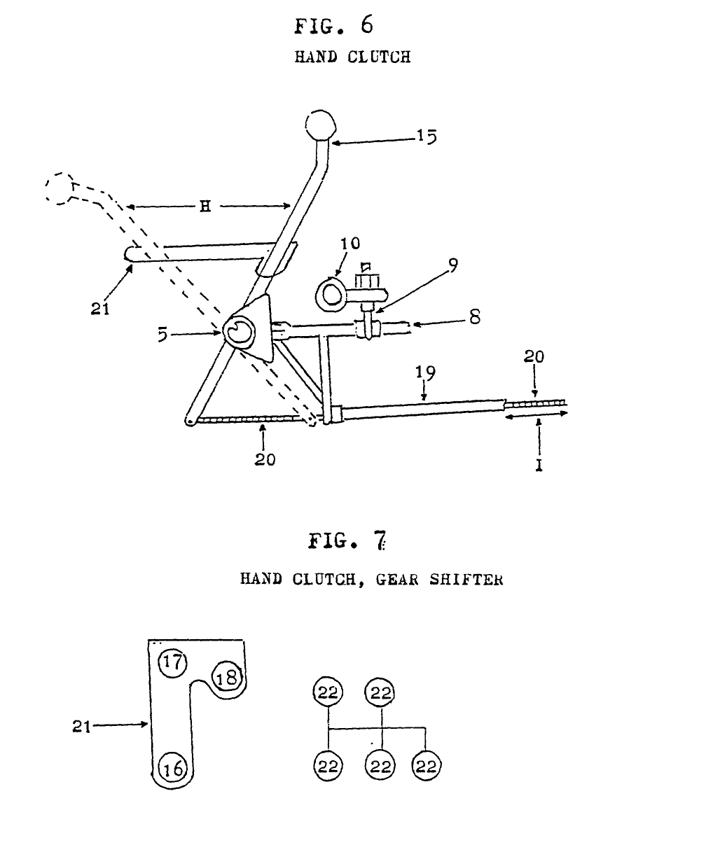

### IDENTIFICATION OF DRAWINGS

1. Brake lever A. Brake cable motion

2. Kill switch B. Brake lever motion

3. Hand throttle C. Hand throttle motion

4. Universal joint D. Throttle cable motion

5. Universal joint housing E. Steering lever motion

6. Brake cable F. Tie rod lever motion

7. Brake cable housing G. Steering column motion

8. Steering column H. Clutch lever motion

9. Steering column bushing I. Clutch cable motion

10. Vehicle frame

11. Throttle cable housing

12. Throttle cable

13. Tie rod lever

14. Tension spring

15. Clutch lever

16. Clutch lever disengaged position

17. Clutch lever engaged position

18. Clutch lever engaged and locked position

19. Clutch cable housing

20. Clutch cable

21. Clutch lever guide plate

22. Gear shifter and positions NEXT

### DETAILED DESGRIPTION OF THE INVENTION

The “Handi-Driver” is a three-in-one hand controll that drives a motorized vehicle by hand. The mechanical elements are a steering column, steering and brake lever, universal joint, a motorcycle type hand throttle, a brake and throttle cable, a kill switch. these elements are combined and become a single unit. The “Handi-Driver” provides steering, throttle, brakes and kill switch. These functions can be activated by the use of one hand, the left or right hand will operate the “Handi-Driver” equally. The steering and brake lever, provides leverage to rotate the steering column, moving the tie rod lever, creating steering. The steering and brake lever, pivits on the universal joint, when the brake lever is pushed, the brake lever pulls the brake cable. The motorcycle type hand throttle when twisted, moves the throttle cable for acceleration. A second “Handi-Driver” will activate a hand clutch, so an automobile with a standard transmission, can be driven by hand.

1. I Keith A. Roberts claim that my invention the“Handi-Driver” when adapted to an automobile, go-kart, or any motorized vehicle, a person with leg paralysis or leg amputee can operate and drive a motorized vehicle with an automatic or standard transmission by the use of one or two “Handi-Driver” hand controlls.

2. Steering is achieved by adapting a mechanical type of action that is or mimics a universal joint, to the end of a steering column, and adapting a lever to the universal joint, the lever provides leverage to rotate the steering column.

3. Braking is achieved by adapting a brake cable to the top end of the steering lever, the steering lever also becomes a brake lever. Pushing the bottom end of the steering and brake lever pivits on the universal joint, when the lever is pushed the top end of the lever pulls a brake cable.

4. Acceleration is achieved by adapting a motorcycle type hand throttle to the bottom end of the steering and brake lever, twisting the hand throttle moves the throttle cable.

5. Clutch is achieved by a second “Handi-Driver”, pushing the clutch lever pulls a cable that engages the clutch, when the clutch lever is fully depressed, the lever can be locked in the engaged position, this frees up the drivers hand so the gears can be shifted, then return to the clutch lever, release the locked position and disengage the clutch.
